(19) United States
(12) Patent Application Publication
(10) Pub. No.: US 2004/0144039 A1
(43) Pub. Date: Jul. 29, 2004

(54) Wood joint

(76) Inventor: Tuomo Tapani Poutanen, Tampere (FI)

Correspondence Address: STITES & HARBISON PLLC, 1199 NORTH FAIRFAX STREET, SUITE 900, ALEXANDRIA, VA, 22314, US

(21) Appl. No.: 10/477,927

(22) PCT Filed: May 22, 2002
(86) PCT No.: PCT/FI02/00438

(30) Foreign Application Priority Data
May 22, 2001 (FI) 20011069

(51) Int. Cl. E04H 9/00; E04H 14/00; B27D 1/00; B27F 7/00

(52) U.S. Cl. 52/1; 144/344

(57) ABSTRACT

The invention relates to a joint between pieces (2) like wood. Into the joint a band (4) is tightened in a special point so that in the joint a moment is produced, where the tensile stresses are transmitted through the band and the compression stresses through contact. Alternatively, the band is placed to run in the joint so that it becomes a hinge.

The invention relates to a joint of a wood like piece and another piece, usually also a wood like piece, according to claim 1.

As to close prior art following inventions can be mentioned:

In the Austrian publication 370475 the use of band in a joint of logs is described.

In the Finnish utility model publication 2106 the use of metal band as tightening means of a pillar is described.

In the American publication U.S. Pat. No. 3,570,376 the structure of a triangular pillar on utilizing metal bands is described.

In the American publication U.S. Pat. No. 6,209,279 the multiple-layered structure of a band is described.

In the English publication 544278 the tightening and locking arrangement of a steel band to be tightened about a wood block is described.

The characteristic feature of the invention is an especially slippery, flexible and flat, most advantageously plastic like band, which is tightened in the wood joint and by means of which in the joint an advantageous impact is formed, either a joining moment or a hinge. Usually, there is in wood joints no moment at all or, in some cases, such one has been made by means of metallic binding pieces, which are, besides being expensive, inferior because of the play pertaining to these joints.

The use of a band as structural connecting means is something new within the woodworking industry. Neither in handbooks nor in schoolbooks of the field a single application nor an example regarding the bands is mentioned.

The band is rope like, the width ratio of its cross-section to its thickness is great, typically at least 5 greater than 8 and usually 10 . . . 30 in largeness. The band is thinner than 2 mm, usually about 1 mm, and usually wider than 8 mm and usually about 20 mm.

The shape of the cross-section, the strength and flexibility of the band and the impact of band slipperiness is essential:

Previously known is the use of wire and also of round rope within timber construction. So that the wire would be flexible its cross-section must be small and thereby the strength of one wire is also small. That is why a great number of wires is required. That leads to the rise of the costs of labour, expense of solution and unaesthetic character. Thus it is not possible either by means of a wire nor any other to its cross-section round or substantially square stretching device to achieve great forces and, accordingly, a solution like this cannot be economically or aesthetically useful.

So that a round or square band would be flexible, it cannot be very strong. Essential in this invention is that the band is exceptionally strong and flexible also. Typically the tensile strength of band is at least about 5-fold to the tensile strength of corresponding wood. Usually the tensile strength is much greater, 10 . . . 30 fold in largeness.

The band must be so flexible and slippery that it can be wound and tightened about the edge or opening of a rectangular piece of wood without a substantial reduction of the band strength or loss of tensile force and without the band penetrating gravely in the wood. Solid metal bands as well as round and square bands lack this feature.

Almost all applications of this invention are of such kind that the band is fitted in a small space, a joint, an opening or on the surface of the structure so that no separate space is arranged for the band but within the fitting tolerances the band is not considered to enlarge the wood product measures, the glue line thickness etc.

The band of this invention is flexible also because it could retain its tightening strength even in quite great deformations due to wood moisture, creep or other circumstances. The band deformation of this invention is at least twofold, but usually much greater, 10 fold in largeness, in comparison to the deformation of a solid steel band in the binding state of tightening. Thus in the application of this invention the band must be as flexible as possible. This claim is contrary to the general claims of the building and the packaging industry, where a stiffness as great as possible is required. Thanks to the flexibility and the pretension permanent tightness free from backlash can be achieved. In present joints there is a play that can be caused by stiff connecting pieces or by the play of fitting means (nails etc.).

The band is easily tightened and bound without slackening and detachably so that the strength of binding is about 50-70% of the band strength. Binding is carried out most advantageously in a way, where no separate connection pieces are needed, for instance by welding or by a knot. In certain cases it is important to tighten or detach the band. Then buckle connection or a knot that can be undone is advantageous. In some cases it is advantageous to use glue either for bonding the band on wood or for binding the band. Bonding and binding the band can be carried out mainly by methods of same type as in the packaging industry.

Typically, the band is made of pretensioned plastic or strong fibres, most advantageously woven and if possible also bound with resin. The band is made of great-strength material, as polyester, polypropylene, polyethylene, aramid polyamide, carbon or glass fibre or other polymer etc. Polyester and especially polypropylene are well suited for the purpose. Most advantageously the band is made of recycling material. In certain cases it is advantageous that the band is made of transparent material or that the band has special colouring or that glass or carbon fibres are added to it in order to increase strength and to reduce creep.

In addition the invention is characterized in that:

anchoring of the band is carried out by means of a link. Present band like connecting elements of the wood industry are anchored with nails, screws etc.

the band is tightened in itself. Typically, present wood industry joints are not tightened at all.

the band is bound in itself usually most advantageously by welding. Present wood industry connecting elements are not especially tightened at all but fastened direct on the wood with nails etc.

Although above mentioned principles are known per se in the technique they are not used in the manufacture of wood joints.

Typically, by means of the invention following advantages are achieved:

The joint is simple, cheap and versatile. By means of a simple band hundreds of ferrules, special screws etc. can be replaced.

The solution is typically a completely ecological and easily disposable element that can be burnt or re-cycled. Corresponding present solutions are, as a rule, based on non-ecological metallic binding pieces, screws etc.

The solution is flexible and adapt to usually quite big deformations caused by moisture in the wood product. This is due to the fact that in this embodiment special demands are made on the qualities of flexibility. Wood gets greatly deformed by changes of moisture and, furthermore, creeps by continuous stress. Thus these deformations are ever greater the more the degree of moisture changes and the greater the stress. In most places of use the cross-section varies depending on the fibre direction appr. from 0.05 to 1%. The band shall adjust to deformations at least of this size, while retaining its state of stress, so that the stress qualities of band can be utilized. The more flexible the band the better it fulfils its impact in the joint, for instance as a 2% strain of band and in certain cases even 3% are technically and economically possible. Concerning the reliability it is advantageous that the wood parts are not more wet at the moment they are being worked than in their final state, most advantageously the wood parts are dryer. Metallic bands as well as stiff plastic bands are not flexible enough for the field of applications of this invention.

The solution is advantageous, typically the material costs and labour costs are only a fraction of the price of present solutions.

The technical implementation of the solution is usually easy to check.

The solution as per the invention is not inclined to corrosion simply because the band can be made of non-corrosive material, such as plastic. The solution of this invention is even not inclined to damages caused by time. Among other things, Harmful influences by ultraviolet radiation and fire can be prevented simply placing the band in the opening inside the piece or covering the band with a lath.

The solution as per the invention has a lot of special qualities, which do not appear in any of the presently known solutions. These special qualities are disclosed in the following.

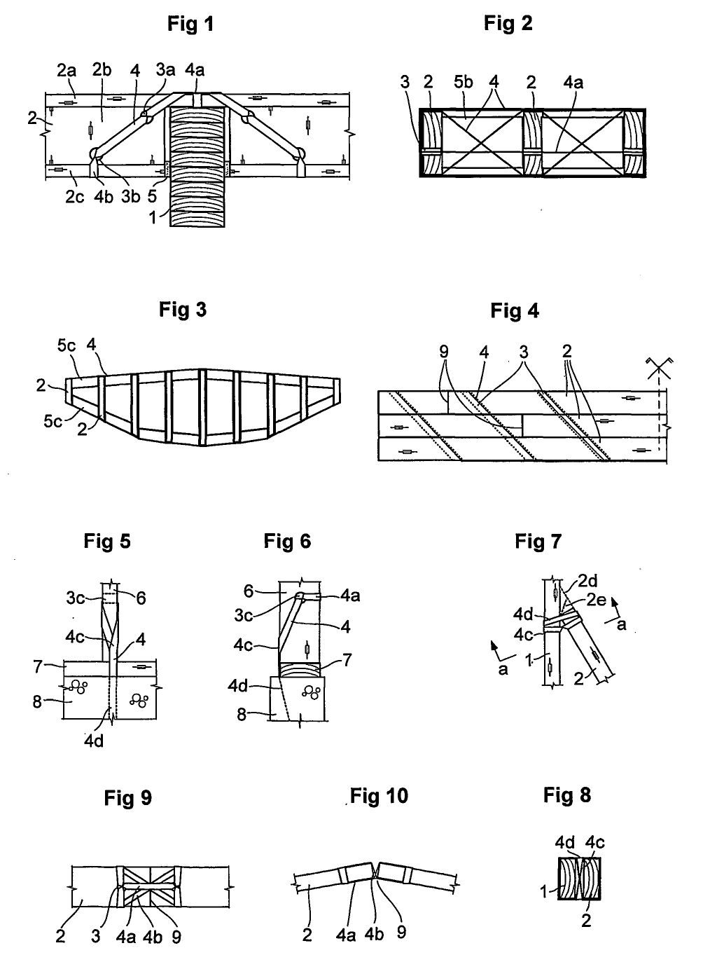

The invention is illustrated in FIGS. 1-10:

FIGS. 1-6 show wood joints, where the function of joist is based on a moment formed by the band tensile forces and the compression forces of joint contacts.

FIGS. 7-10 show the joint working as a hinge.

FIG. 1 shows connection of an I joist to a support. To their structural function I joists are effective and economical, that is why the use of them has grown lately. A lot of problems are associated with such kind of joints supporting I joists an other timber joists, and the fitting of the support is often complicated and expensive. This relates to all three forms of supporting: The joist resting completely on the support, partly on the support and completely on one side. In most cases the most advantageous supporting would be by side support of joist on the upper flange. However, such kind of supporting has not been possible, since the timber joists do not bear the joist tensile stress formed by the way of above mentioned supporting. The problem is solved in FIG. 1 so that beside supporting other advantageous effects, as reduction of joist head shear stresses and of transverse tensile stresses, are achieved as well as a negative moment in the joist head. Joist 2 rests on both sides of support 1. Such a case is quite usual within building. Band 4 runs on both sides of web 2b, crosses at opening 3b and forms a link about lower flange 2c. In its upper part the band crosses through opening 3a, runs about upper flange 2a and continues in the same way to the joist on the right side. Alternatively opening 3a can be lacking, whereby band 4 can run direct from opening 3b to the flange upper surface 4a. Alternative both openings can be lacking and band 4 run below the lower flange reaching in the same way to the other end of joist 2. Essential is that the force active in the band stretches joints 2 to each another in point 4a in its upper part. Essential also is that compression forces corresponding to the tensile forces and holding the joists apart are in the joist lower part. In the embodiment in the figure this has been carried out so that between support 1 and joist 2 there is a fitting piece 5, most advantageously of wood, possibly also of some other material. This fitting piece can be made adjustable to its thickness, for instance adapting the wedge principle or similar. By this means the joist bending can be regulated, which is essential, if joist 2 works completely or partly as a cantilever projecting from support 1. A case like this corresponds to the Finnish Utility Model 203, where the adjustment is arranged more complicatedly and more expensively to the upper part of the joist (or cross beam). Alternatively there is no fitting piece 5 at all and the lower flange 2c reaches farther than web 2b. By means of the solution as per the figure it is achieved that the joist shear strength falls essentially and due to it band 4 takes a part of the shear load, the joist can be supported on the upper flange, because due to stress caused by band 4, no traverse tensile stresses arise or they are minor. In addition, into the joist, at the support, a negative moment is achieved, which is formed by band 4a tensile force and wedge 5 compression. Thanks to the above mentioned moment the strength of joist increases, typically appr. 50% and the bending reduces appr. 70%. Adjusting the band 4 tensile stress and the angle of band 4 to joint 2 (and possibly also adjusting fitting piece 5) the size of the negative moment, joint 2 shear stresses and tensile stresses can be adjusted. Most advantageously these are adjusted to such a rate that to its absolute value the negative moment is the half of the moment of a corresponding freely supported joist and at least 25% of this rate, and to such a rate that there is at the support in web 2b no tensile stress at all. The solution is feasible even in a case, where joist 2 is only on one side of support 1. Then the band cannot be tightened in point 4a, whereby no negative moment can be achieved in the joist, but the shear stresses and traverse tensile stresses get reduced. The presented solution is suited for all wood like joists and not only I joists.

FIG. 2 shows the cross-section of an intermediate wood floor, a roof element or similar in a building, which have parallel joists 2, generally at a distance of 300 . . . 1200 mm from each other, in the figure version the joists are of sawn wood. Usually there are above and below the joists board structures, which are not shown in the figure. The problem in such a structure is the poor structural interaction between the joists. In order to produce such an interaction numerous solutions have been developed, disclosed among other things in the publications U.S. Pat. No. 4,333,294, U.S. Pat. No. 4,794,746, U.S. Pat. No. 5,937,608 and U.S. Pat. No. 49,747,612. They are all expensive, but yet modest to their technical capacity, because transverse bonds of this kind are not particularly rigid, since in them the join plays are disturbingly great and, in any case, the stiffness and, the strength are small. A new effective and advantageous solution is presented in the figure. Between joists 2 distance pieces 5b, for instance of sawn wood, are fitted and essentially of same height as the joists or, most advantageously, a little lower, whereby a gap remains between the upper and lower slab of the distance piece, into which installation tubes and installation cables of building can be placed. Alternatively there are several distance pieces of wood assembled in the shape of letter X letter. At distance pieces 5b in joist 2 openings 3 a band 4a is fitted, by means of which distance pieces 5b are tightened in joists 2 so that between distance pieces and joist a compression stress of at least 0.05 Mpa, most advantageously of <0.1 Mpa is produced. Band 4a is placed in joist 2 openings, since the distance pieces work as a joist like moment-bearing cross support so that band 4a bears the tensile forces and usually, in addition, the slab above joist 2 bears the compression forces, whereby joists 2 and distance pieces 5b form a grid construction. Alternatively, bands 4 can be placed about the whole cross-section or they can be placed crosswise. It is, however, advantageous that a least the major part of the bands are in the lower parts of joist 2 or on the lower surface, where the tensile stresses are effective. Usually, for each span of joist 2 only one distance piece is needed placed in the middle of the span. Such a joist formed of distance pieces and the band is so effective that by means of it, in addition to the transverse support, the cross beam, can be replaced due to the cut-off of joists 2. By means of the new solution it is, among other things, also possible to make in the joist slab a round, a polygonal or a similar opening without supporting the joists from below or from above.

FIG. 3 shows the cross-section of a timber-work bridge made by lamination. The outer surfaces are formed of wood parts 5c of solid wood, gluelam, veneer or cants or similar wood. In addition, the bridge has wood parts 2 also of solid wood or laminar wood or some other material. All these wood parts are tightened together by band 4 either about the whole cross-section and/or partly about the cross-section or the upper and the lower part are separately tightened together with the band in the openings in wood parts 2 or also in wood parts Sc. So that the band would not be left visible on the outer surface it is usually advantageous to cover it with a lath or similar. Alternatively, openings are made in wood parts 2 and 5c, into which the band is placed. Essential in the cross-section is that its bearing capacity rests substantially on the moment that, on the other hand, is produced by means of the band along the curved way and, on the other hand, by means of wood contact. Presently corresponding bridges are built of wood by so called compressive lamination technique using straight steel bars, among other things according to Finnish publication FI000100414. Compression stresses are produced by straight steel bars, which restricts the cross-sections to plane like pieces only, and in solutions like these ones the impact of the moment improving the bearing capacity cannot be effectively utilized. There are in these bridges other disadvantages, such as anchoring of bars and periodic tightening because of wood creep and moisture fluctuations.

FIG. 4 shows a doweled beam with three logs 2 or similar one on top of another. In them openings 3 are made, into which bands 4 are installed. The openings are placed crosswise so that the bands are arranged in two sequential openings and tightened in regard to the joist web on the lower joist surface and the bands forming via the sequential openings a link on the upper surface. Such bands join the joists 2 effectively together and produce, in addition, a pre-stretching doweled beam effect so that the whole joist bends upward, tensile stress is formed in the lowest joists and compression stress the top joists. Such kind of band assembly is most advantageous, since there can the joists 2 can have splicings 9, which need not be tightened especially, since the compression stresses run by means of connection over the splicings. The bearing capacity ofjoist rests even in this case on the moments produced by compression stresses of contacting surfaces of the wood parts.

FIGS. 5 and 6 show the joining of a wood wall post to socket 8, usual by timber construction. FIG. 5 shows the post in front of the wall and FIG. 6 on the side. In addition the construction includes, fastened at least on the other board surface, a building board, not illustrated in the figure, and which together with the post forms a stiffening and moment-bearing wall. Post 6 has an opening 3c into which band 4 is anchored in twining band 4 over edge 4a, possibly also over another edge or, depending on the requirements of strength, the band is not wound over the post edge at all. Opening 3c can be lacking, whereby the band can be anchored in the post upper end or in the notch in the joist. The band runs from the outside of lower runner 7—or alternatively from the inside or through the opening—to the socket and possibly also to the footings of the wall, where band 4 is anchored. The anchoring can also be of such kind that instead of socket there is an underside post, in which the band lower part is anchored in the same way as even the upper part. The same solution is also suited for an anchoring of such kind that the post gets anchored to the overhead joist, cross beam or the whole trussed roof or similar. Band anchoring gives rise to compression force in the post, due to which it is advantageous to carry out the anchoring in a post with minor compression force. Such anchoring is today carried out by expensive and inflexible metallic joining pieces, among other things according to the publications U.S. Pat. No. 5,979,130, U.S. Pat. No. 6,006,487, U.S. Pat. No. 5,666,781 and U.S. Pat. No. 5,732,524. Even in this case the bearing capacity of the structure lies on the moment, that is formed by tractive band forces and compressive contacting forces.

FIGS. 7 and 8 show the same joint of joist 2 to support 1. FIG. 6 shows section a-a of FIG. 5. Joist 2 joins diagonally the side of support 1, in this case in an angle of ab. 30 degrees, but the joining angle can be of any size, even 90 degrees. Depending on the requirements of strength, band 4c is wound one or several times about joists 1 and 2 forming the shape of number 8 one or several times. In addition, another or the same band 4d is possibly also wound into number 0 shape evenly about joists 1 and 2. Essential in the joint is band 4c that makes the joint strong and is of such kind that the angle between support 1 and joist 2 can be changed, when the joint is finished. This means, among other things, that the joint can be produced in a factory and for transportation joist 2 can be placed on one side of support beam 1 (i.e. the angle between them is 0) and on the site joist 2 is turned into an angle wanted. This feature does not exist in any previously known joint. Joist 2 head can be cut-off right-angled, which is most simple with respect to manufacturing technique. Alternatively, the head can be cut-off a little diagonally as shown by broken line 2e. Such a cut-off can be advantageous, because for bands 4c and 4d more adhesion space can be arranged and they are close to the torsion centre between joist 2 and support 1. Usually, joist 2 head needs not to be cut-off exactly according to the final angle of joining in the way applied to present joints, which is presented by broken line 2d. The above described flexible feature related to joist 2 head cut-off does no exist in the joist known today. The same join solution is suited even for the case, where in addition to the horizontal plane the angle of joist 2 is in regard to support also changed in the vertical plane. Even this feature does not exist in any previously known joint. The described joint solution replaces the earlier known complicated, expensive, non-flexible and metal joints only applicable for jointings in a work-place; such joints being described among others in publications U.S. Pat. No. 5,457,928, U.S. Pat. No. 5,341,619, U.S. Pat. No. 5,220,766 and U.S. Pat. No. 5,253,465.

FIGS. 9 and 10 show a hinge splice 9, which splice is produced by means of bands 4a and 4b. The bands are anchored in openings 3 winding them about the edges of joist 2. FIG. 10 shows the splice from above in bent position. The hinge effect is achieved simply so that a part of the bands 4b is arranged to run crosswise in the joint and the other part only to the joist 2 other side so that the bands run also crosswise. The presented splice is very strong, because due to the fact that the bands can be anchored even far in the element internal parts or even about the whole element. The solution is also most advantageous. By means of it even big size elements can be manufactured, such as wall, roof and beam elements for buildings and folded together in small volumes for transportation. Such kind of transportation has not been possible earlier, because hinges advantageous and strong enough have not been available.

Figure references

1. Support, joist

2. Joist

2a upper part

2b lower part

2c web

3. Opening

3a upper opening

3b lower opening

3c pillar opening

3d joist opening

4. Band

4a upper part, upper loop

4b lower part, lower loop

4c joint line band 1

4d joint line band 2

4e joint line band 3

4f joint line band 4

5. Fitting piece

5a corner piece

6. Post, joint line

6a connecting part

7. Lower runner

7a base, connecting piece

8. Socket, fundament

9. Nail

10. Joist head

11. Bushing

12. Coating (bitumen, concrete)

13. Fascia

14 Building board

15 Concrete

16 Angle iron

1. A method to make a joint or to improve its qualities between a wood block or a wood element, as sawn wood, veneer, LVL, LVS, an I joist, a gluelam beam, and at least another block of wood characterized in that
in the joint at least one band (4) is fitted, which is thin, the width/thickness of its cross-section >5, most advantageously >10, and for instance made of flexible and slippery material like plastic, the relative stretch of which in binding situation is >1%, most advantageously 2%,
band (4) is tightened so that the compression caused by the band force in the joint line or in the wood is at least in one point >0.05, most advantageously <0.1 Mpa.
in the joint band (4) is fitted in a special place, especially on the block surface, where the band produces a wanted impact either a moment stress acting in a direction wanted, whereby the band receives the tensile stresses of the moment and the joint contact the compression stresses, or the band is fitted in such a corner, about which the element is bent for transportation or moving,
the band is arranged to move along the curved way,
the band is tightened in itself,
the band is tightened in itself, most advantageously by welding,
the band is anchored in the structure by means of a link at least from its one end.

2. A method according to claim 1 characterized in that band (4) working as a hinge between the elements is fitted to run crosswise in two planes in the folding point between the elements.
